(19) United States
(12) Patent Application Publication
(10) Pub. No.: US 2012/0239410 A1
(43) Pub. Date: Sep. 20, 2012

(54) METHOD, APPARATUS AND COMPUTER PROGRAM PRODUCT FOR DEVELOPING COST-EFFECTIVE, EVIDENCE-BASED TREATMENT PATHWAYS USING A DATA-DRIVEN APPROACH

(75) Inventors: Kim Bergstrom, Belvedere-Tiburon, CA (US); Brandon Tom, Oakland, CA (US); Diana Verrilli, Boulder, CO (US)

(73) Assignee: Onmark, Inc.

(21) Appl. No.: 13/049,971

(22) Filed: Mar. 17, 2011

(51) Int. Cl. G06Q 50/22

(52) U.S. Cl. 705/2

(57) ABSTRACT

A method for developing cost-effective, evidence-based treatment pathways using a data driven approach may include receiving information indicative of prescribing patterns associated with one or more drug regimens employed by an organization for treatment of a disease, receiving information indicative of financial performance of the one or more drug regimens, receiving information indicative of clinical efficacy of the one or more drug regimens, and enabling development of a treatment pathway based on the information received indicative of financial performance and clinical efficacy. A corresponding computer program product and apparatus are also provided.

### TECHNOLOGICAL FIELD

Embodiments of the present invention relate generally to health care management solutions and, more particularly, relate to a mechanism for developing cost-effective, evidence-based treatment pathways using a data-driven approach.

### BACKGROUND

Many aspects of the provision of medical care and the management of many aspects of the healthcare system now involve the use of computers and computer applications. For example, recent efforts have been made to move to electronic medical records (EMR). With clinical documentation systems moving to electronic media, clinical data may be available for incorporation into a number of different applications designed to assist in the management or use of such data. Computerized provider order entry (CPOE) is another example of a development that may improve the ability to electronically access information related to physician's orders. Many other applications are also being developed to utilize electronic information on people and processes to manage the provision of various aspects of patient care including the provision of predictive care.

As is to be expected, the demand for applications that can be used for streamlining the provision of health care services and the management of health care-related information has led to the development of many new applications by many different providers. However, these applications are often very specific to certain organizations and to certain tasks. Thus, there is often still a lack of ability for patient treatment within specific communities to be streamlined to develop clinical pathways that promote evidence based medicine, while also providing efficient and cost effective treatment. Moreover, there is a general lack of technological solutions to aggregate prescribing data and report it in meaningful ways.

### BRIEF SUMMARY

A method, apparatus and computer program product are therefore provided to enable the provision of cost-effective, evidence-based treatment pathways using an data-driven approach. In this regard, some embodiments may provide a system configured to receive information on previous prescribing data and report the clinical efficacy and financial performance associated with that data. This reporting mechanism will enable the cost-effective selection of regimens for addition to a standardized pathway and also monitor adherence of future prescribing to the pathway.

In one example embodiment, a method for developing cost-effective, evidence-based treatment pathways using a data driven approach is provided. The method may include receiving information indicative of prescribing patterns associated with one or more drug regimens employed by an organization for treatment of a disease, receiving information indicative of financial performance of the one or more drug regimens, receiving information indicative of clinical efficacy of the one or more drug regimens and enabling development of a treatment pathway based on the information received indicative of financial performance and clinical efficacy.

In another example embodiment, a computer program product for developing cost-effective, evidence-based treatment pathways using a data driven approach is provided. The computer program product may include at least one computer-readable storage medium having computer-executable program code instructions stored therein. The computer-executable program code instructions may include program code instructions for receiving information indicative of prescribing patterns associated with one or more drug regimens employed by an organization for treatment of a disease, receiving information indicative of financial performance of the one or more drug regimens, receiving information indicative of clinical efficacy of the one or more drug regimens, and enabling development of a treatment pathway based on the information received indicative of financial performance and clinical efficacy.

In another example embodiment, an apparatus for developing cost-effective, evidence-based treatment pathways using a data driven approach is provided. The apparatus may include processing circuitry. The processing circuitry may be configured for receiving information indicative of prescribing patterns associated with one or more drug regimen-related treatment pathways employed by an organization for treatment of a disease, receiving information indicative of financial performance of the one or more drug regimens, receiving information indicative of clinical efficacy of the one or more drug regimens, and enabling development of a treatment pathway based on the information received indicative of financial performance and clinical efficacy.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating a system for use in connection with developing cost-effective pathways for treatment using an evidence-based approach according to an example embodiment of the present invention;

FIG. 2 is a block diagram showing various components that may be included in an apparatus for developing cost-effective, evidence-based treatment pathways using a data driven approach according to an example embodiment of the present invention;

FIG. 3 illustrates an example of a report regarding utilization patterns (# regimens used over a given time period) and average cost and reimbursement associated with that utilization according to an example embodiment of the present invention;

FIG. 4 illustrates a report regarding national guideline and practice-specific pathway compliance according to an example embodiment of the present invention;

FIG. 5 illustrates an example of phases that may be associated with utilization of the pathway analyzer to improve cost efficiency and efficacy of care provided using an example embodiment of the present invention;

FIG. 6 illustrates a process flow according to an example embodiment of the present invention; and

FIG. 7 is a block diagram according to an example method for developing cost-effective pathways for treatment using an evidence-based approach according to an example embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, embodiments of the present invention are aimed at providing a mechanism by which to provide cost-effective, evidence-based treatment pathways using a data driven approach. Various different medical practices are spread all over the country and have different focuses and different scales. For example, some major health care systems have a very wide regional footprint and bring to large amounts of resources to bear in relation to streamlining their practices. However, other smaller practices such as community based providers may lack the technology, data, and clinical resources to adequately develop clinical pathways that promote evidence based medicine, while also keeping their practices financially viable and lowering overall health care costs. Treating patients in an efficient and cost effective manner is becoming increasingly important. Particularly in practices where specialty drugs are commonly employed (e.g., oncology practices), cost and efficiency can become acutely important.

Growth in connection with the use of specialty drugs has represented a disproportionately large segment of the pharmaceutical market in recent years. For example, in recent years, specialty drugs have represented 25% of the pharmaceutical spend in the U.S. market and cancer drug development is currently outpacing the next closest category (cardiovascular drugs) by a ratio of 6 to 1. Thus, there are and will continue to be vast amounts of drugs available for cancer and other disease treatments. Some treatments, like cancer treatments, can be very complex, such that multiple treatments may be defined even for using the same drugs (e.g., with different dosing or prescribing patterns). For many treatments, there may be literature or published studies describing the effectiveness of the treatment. In some cases, there may be national guidelines provided for certain clinical pathways. There may also be data available for mining that could enable various treatment pathways to be classified and assessed in terms of either or both of their clinical effectiveness and their cost effectiveness.

Some example embodiments of the present invention may enable these pieces of information to be combined together into a useable format in order to allow medical treatment entities, such as community oncologists or numerous other practitioners, to successfully assess their own historical prescribing patterns, benchmark that data against national guidelines, perform cost and reimbursement comparisons of different regimen options, and forecast the financial implications of streamlining their prescribing. Thus, users of example embodiments may be enabled to take a proactive approach to developing pathways that adhere to high levels of evidence-based medicine while also paying attention to the incentives of payors.

In the context of the examples described herein, the term “regimen” should be understood to be descriptive of a single treatment plan for a single patient. The regimen for a patient includes a combination of drugs, their doses and administration techniques along with a schedule for how often the drugs are to be administered. The term “pathway” should be generally understood to be descriptive of a list of preferred regimens that are agreed upon for use by a group of physicians when treating a particular type of patient, in a particular line of therapy (adjuvant, 1^{st} line metastatic, etc.). For example, regimen X may be given to a patient with stage III colon cancer for treatment in the “Adjuvant setting” after surgery to remove the primary tumor. Some example embodiments of the present invention may provide a data driven reporting solution that enables physicians to select regimens to be added to a pathway based on a collection of data regarding regimens including historical prescribing patterns, clinical efficacy data for various regimens and profit margins for each of the regimens. Forecasting may then be performed to illustrate potential financial implications of implementing a pathway.

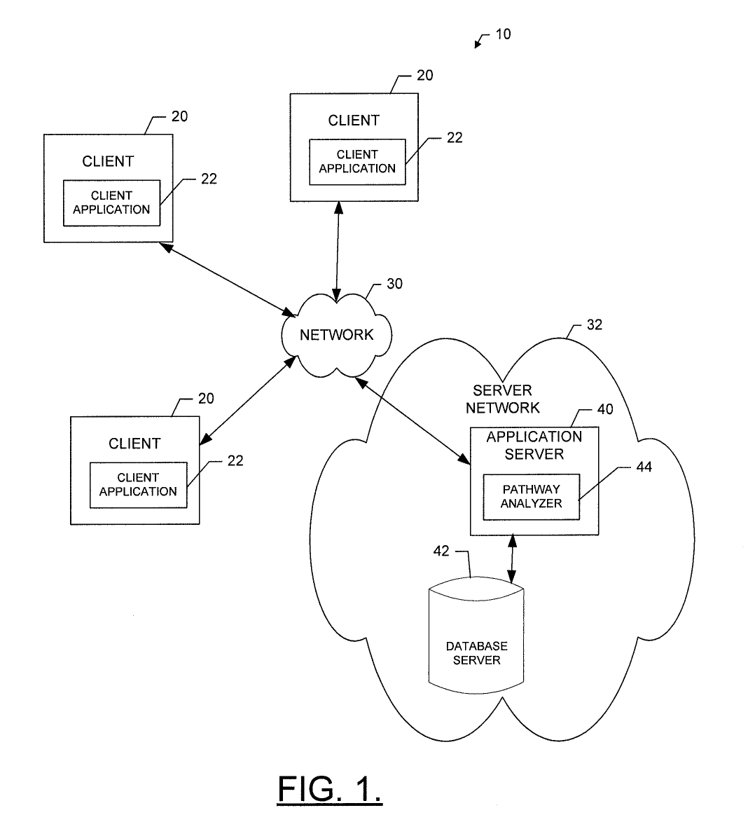

An example embodiment of the invention will now be described in reference to FIG. 1, which illustrates an example system in which an embodiment of the present invention may be employed. As shown in FIG. 1, a system 10 according to an example embodiment may include one or more clients 20 that may, in some cases, be associated with different corresponding healthcare related entities associated with one or more health care organizations or systems. For example, one client 20 may be associated with a first community oncologist in one area and a second client 20 may be associated with a second community oncologist in another area. However, in some cases, additional clients may be associated with the same healthcare organization or system or even all clients could be associated with the same healthcare organization or system. As such, in some cases, multiple clients may be associated with the same organization.

Each client 20 may be, for example, a computer (e.g., a personal computer, laptop computer, network access terminal, or the like) or may be another form of computing device (e.g., a personal digital assistant (PDA), cellular phone, or the like) capable of communication with a network 30. As such, for example, each client 20 may include (or otherwise have access to) memory for storing instructions or applications for the performance of various functions and a corresponding processor for executing stored instructions or applications. Each client 20 may also include software and/or corresponding hardware for enabling the performance of the respective functions of the clients as described below. In an example embodiment, one or more of the clients 20 may include a client application 22 configured to operate in accordance with an example embodiment of the present invention. In this regard, for example, the client application 22 may include software for enabling a respective one of the clients 20 to communicate with the network 30 for the provision of and receipt of information associated with determining cost-effective pathways using an evidence-based approach. As such, for example, the client application 22 may include corresponding executable instructions for configuring the client 20 to provide corresponding functionalities for the provision of and receipt of information associated with providing reports regarding regimen options and/or processing data needed to generate reports as described in greater detail below.

The network 30 may be a data network, such as a local area network (LAN), a metropolitan area network (MAN), a wide area network (WAN) (e.g., the Internet), and/or the like, which may couple the clients 20 to devices such as processing elements (e.g., personal computers, server computers or the like) or databases. Communication between the network 30, the clients 20 and the devices or databases (e.g., servers) to which the clients 20 are coupled may be accomplished by either wireline or wireless communication mechanisms and corresponding protocols.

In an example embodiment, one of the devices to which the clients 20 may be coupled via the network 30 may include one or more application servers (e.g., application server 40), and/or a database server 42, which together may form respective elements of a server network 32. Although the application server 40 and the database server 42 are each referred to as “servers”, this does not necessarily imply that they are embodied on separate servers or devices. As such, for example, a single server or device may include both entities and the database server 42 could merely be represented by a database or group of databases physically located on the same server or device as the application server 40. The application server 40 and the database server 42 may each include hardware and/or software for configuring the application server 40 and the database server 42, respectively, to perform various functions. As such, for example, the application server 40 may include processing logic and memory enabling the application server 40 to access and/or execute stored computer readable instructions for performing various functions. In an example embodiment, one function that may be provided by the application server 40 may be the collection of information to generate reports described herein for enabling financial information, inventory information, clinical data, guideline information and/or the like that is received at the application server 40 (and/or stored at the database server 42) to be used for generation of various reports described herein. In some embodiments, for example, the application server 40 may include a pathway analyzer 44 comprising stored instructions for handling activities associated with practicing example embodiments as described herein.

Additionally or alternatively, the application server 40 may be configured to enable the clients 20 to provide information to the application server 40, for use by the application server 40 in producing, maintaining and/or supplying the reports. In this regard, for example, the application server 40 (or servers) may include particular applications related to various different data entry, management and/or storage modules. As such, some application servers may host data entry mechanisms that enable the entry of various different types of information, perhaps with different formats and protocols, to be received and processed and/or translated as needed to permit storage in the database server 42 in a manner that will enable extraction of needed information for report generation as described herein. In other words, the database server 42 may form a storage repository to accept various types of information and order the information in a form that is useable by the application server 40 (or at least the pathway analyzer 44) to be processed for report generation as described herein.

In an example embodiment, the application server 40 may include or have access to memory (e.g., internal memory or the database server 42) for storing instructions or applications for the performance of various functions and a corresponding processor for executing stored instructions or applications. In an example embodiment, the application server 40 may include the pathway analyzer 44 configured to operate in accordance with an example embodiment of the present invention. In this regard, for example, the pathway analyzer 44 may include software for enabling the application server 40 to communicate with the network 30 and/or the clients 20 for the provision and/or receipt of information associated with providing persistent storage of data that is accessible for querying via a user friendly interface. As such, for example, the client application 22 may include corresponding executable instructions for configuring the client 20 to request information (e.g., via the pathway analyzer 44) regarding one or more treatment pathways that may be identified by a standard name, by an assigned name or serial number, or by a description of the activities associated with the corresponding treatment pathway to enable the presentation of the information at the client 20. The pathway analyzer 44 may therefore be configured to provide corresponding functionalities for the provision and/or receipt of information associated with providing the requested information as described in greater detail below.

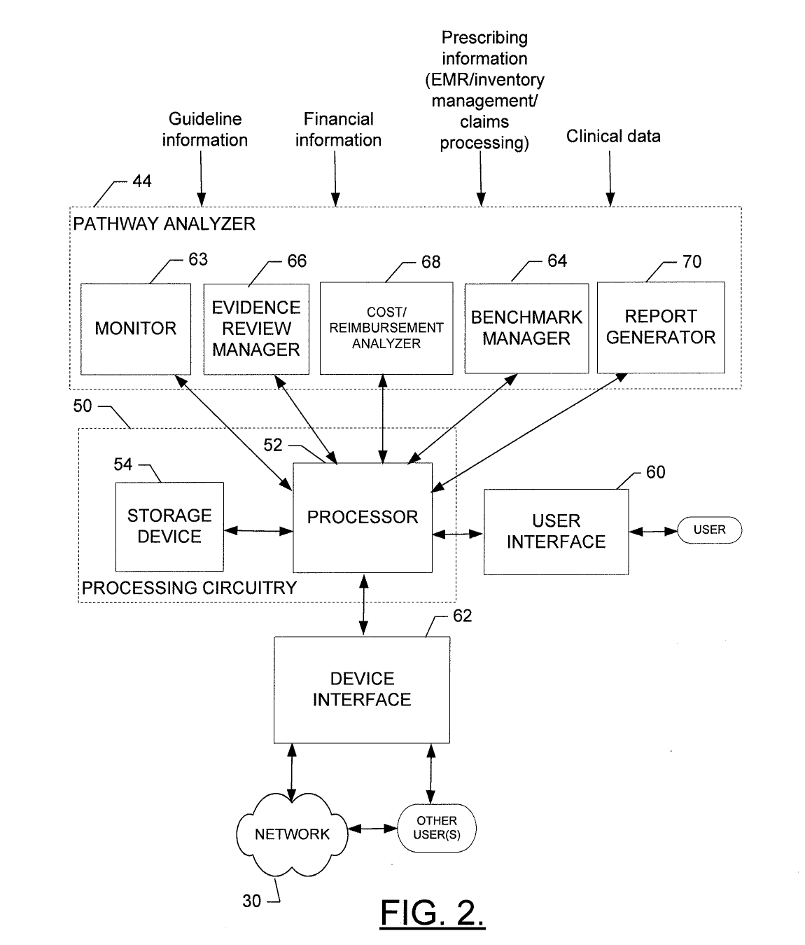

An example embodiment of the invention will now be described with reference to FIG. 2. FIG. 2 shows certain elements of an apparatus for enabling development of cost-effective, evidence-based treatment pathways using a data driven approach according to an example embodiment. The apparatus of FIG. 2 may be employed, for example, on a client (e.g., any of the clients 20 of FIG. 1) or a variety of other devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40) or by devices in a client/server relationship (e.g., the application server 40 and one or more clients 20). Furthermore, it should be noted that the devices or elements described below may not be mandatory and thus some may be omitted in certain embodiments.

Referring now to FIG. 2, an apparatus for enabling development of cost-effective, evidence-based treatment pathways using a data driven approach is provided. The apparatus may provide a structure to perform functionalities including data collection, the addition of clinical and financial intelligence, and the generation of reports from a single location. The apparatus may include or otherwise be in communication with processing circuitry 50 that is configured to perform data processing, application execution and other processing and management services according to an example embodiment of the present invention. In one embodiment, the processing circuitry 50 may include a processor 52, a storage device 54 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device such as one of the clients 22) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms. In embodiments where the apparatus is embodied at a server or other network, entity, the user interface 60 may be limited or even eliminated in some cases.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the storage device 54 may include one or more non-transitory storage or memory devices such as, for example, volatile and/or non-volatile memory that may be either fixed or removable. The storage device 54 may be configured to store information, data, applications, instructions or the like for enabling the apparatus to carry out various functions in accordance with example embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g., database server 42) that may store a variety of files, contents or data sets. Among the contents of the storage device 54, applications (e.g., client application 22 or pathway analyzer 44) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an example embodiment, the processor 52 (or the processing circuitry 50) may be embodied as, include or otherwise control the pathway analyzer 44, which may include or otherwise control a monitor 63, a benchmark manager 64, an evidence review manager 66, a cost/reimbursement analyzer 68 and a report generator 70. The monitor 63, the benchmark manager 64, the evidence review manager 66, the cost/reimbursement analyzer 68, and the report generator 70 may each be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the monitor 63, the benchmark manager 64, the evidence review manager 66, the cost/reimbursement analyzer 68, and the report generator 70, respectively, as described below.

As shown in FIG. 2, the pathway analyzer 44 may be configured to receive information from numerous sources and generate reports for enabling cost-effective decisions to be made with regard to pathway creation. In some cases, the information may be received directly from an information repository associated with the corresponding type of information (e.g., inventory information may be received directly from an inventory management application or database storing inventory related information). However, in other cases, the information may be received from third parties or other sources that collect the corresponding type of information. Moreover, in some embodiments, the information may be collated or collected by the pathway analyzer 44 itself, or by another device or module associated with the apparatus. The information received may include guideline information descriptive of national guidelines for treatment pathways for various types of diseases (e.g., cancer or other diseases with drug related treatment regimens) and clinical data descriptive of studies or other literature evaluating the efficacy of various treatment pathways. In some cases, the information received may also or alternatively include inventory information descriptive of drug usage in association with various treatment regimens and financial information. The inventory information received may be provided by an inventory management tool (e.g., Lynx Mobile® and/or the like) that is configured to manage inventory levels and automate ordering. The inventory management tool may be configured to report detailed drug data including frequency and dose information along with the diagnosis and stage of the patient to which the drug was prescribed. Other information such as line of therapy, treatment setting, patient identity, payor identity and/or the like may also be provided. The financial information may be descriptive of the cost associated with a treatment pathway and/or the reimbursement paid for the corresponding treatment pathway. In some cases, the pathway analyzer 44 may also be configured to receive electronic medical record (EMR) information that may be used for various purposes including determining inventory information.

The benchmark manager 64 may be configured to receive the guideline information and inventory information in order to determine the regimen utilization patterns of a particular organization. For example, the benchmark manager 64 may be employed by the particular organization to determine the current regimen utilization patterns of the particular organization. However, in some cases, the benchmark manager 64 may be utilized with respect to a plurality of organizations and regimen utilization patterns may be determined for respective different ones of the organizations. In any case, after a regimen utilization pattern has been determined, the benchmark manager 64 may be configured to compare the regimen utilization pattern to national treatment guidelines. In other words, the benchmark manager 64 may be configured to benchmark the regimen utilization pattern against national treatment guidelines. Reports may then be generated to illustrate results of the comparison over a plurality of national treatment guideline criteria. In some embodiments, the reports may include selectable criteria and/or selectable formatting options to provide flexibility for display at a client device (e.g., one of the clients 20). Each treatment pathway or regimen that is benchmarked (or for which financial and efficacy information is determined as described below) may be identified by a standard name, a descriptive title, a serial number or other identifier.

In some embodiments, the cost/reimbursement analyzer 68 may be configured to produce cost and/or reimbursement analysis of different regimens used (by the organization), in order to provide the organization with an understanding of their average profit per regimen and average cost to a payor for the various regimens the organization utilizes. The cost/reimbursement analyzer 68 may be configured to receive information related to cost and/or reimbursement for one or more organizations related to the various treatment regimens that are utilized by the organizations. The cost/reimbursement analyzer 68 may also be configured to forecast the financial impact of potential prescribing patterns resulting from pathway development suggested by the pathway analyzer 44. As such, for example, based on the information and reports that can be generated by the cost/reimbursement analyzer 68, the pathway analyzer 44 may be configured to illustrate projections for costs and/or reimbursements for a selected or suggested treatment pathway or regimen. Thus, for example, the cost/reimbursement analyzer 68 may be configured to provide information that enables an organization to meet financial goals of the organization while providing quality care. This may be accomplished by providing information that enables the organization to view the financial costs and/or reimbursements associated with various treatment regimens (that can be tied to or further described in terms of their efficacy from a clinical standpoint) to further enable selection of treatment pathways based on both financial and efficacy criteria.

The evidence review manager 66 may be configured to provide information on the efficacy of various treatment regimens. In this regard, for example, the evidence review manager 66 may be configured to provide clinical content and supporting data and tools to determine which treatment regimens are most clinically effective. In some embodiments, the evidence review manager 66 may be configured to rate the efficacy of various treatment regimens. Thus, for example, the identifier of one or more different treatment regimens may be provided in association with a value, rating or ranking to illustrate the clinical effectiveness of the corresponding treatment regimen. The value, rating or ranking may be based on, or in some cases accompanied with, clinical reports or evidence regarding the effectiveness of various different treatment regimens. In an example embodiment, the evidence review manager 66 may be configured to receive information from other organizations or from a central clinical data warehouse including efficacy data for numerous organizations and numerous treatment regimens. As such, the evidence review manager 66 provides an evidence-based regimen rating, scoring or ranking device to help physicians understand the effectiveness of certain treatment regimens. The evidence review manager 66 may also be configured to perform diagnosis cleansing, treatment setting assignment, regimen naming normalization (e.g., identifier standardization), and/or guideline adherence filtering. The evidence review manager 66 may therefore provide clinical content (e.g., clinical study results, clinical trial data, side effect comparisons, scholarly articles, magazine or periodical articles, research papers, etc.) and supporting data and tools to determine which regimens are most effective.

As such, using tools such as the benchmark manager 64, the evidence review manager 66, and the cost/reimbursement analyzer 68, the pathway analyzer 44 may be configured to receive information indicative of current treatment regimens employed by an organization and also receive information indicative of the financial impact and clinical efficacy of those treatment regimens. In some cases, information may also be provided regarding the financial impact and clinical efficacy of other treatment regimens as well (e.g., those utilized or studied by other organizations). The pathway analyzer 44 may then enable reports to be generated to compare the financial impact and clinical efficacy of various different treatment regimens to enable the organization to design one or more treatment pathways based on their expected financial impact and clinical efficacy. However, the pathway analyzer 44 may be further configured (e.g., via the monitor 63) to monitor adherence within the organization to the selected treatment pathways and to generate (e.g., via a dashboard) reports for viewing reports and forecasting implications of altering prescribing patterns. As such, according to some example embodiments, the pathway analyzer 44 may be configured to generate a dashboard display and corresponding user interfaces to allow users to select reports they would like to view and/or generate. The reports may be set up with selectable characteristics to enable flexibility with respect to the way information may be presented for user consumption.

In an example embodiment, the monitor 63 may be configured to receive inventory and/or EMR data associated with treatment pathways employed by the organization. The monitor 63 may be enabled to determine correspondence between a prescribing pattern being utilized and an identifier of a particular treatment pathway known to the pathway analyzer 44. The monitor 63 may then determine whether the identifier that corresponds to a particular prescribing pattern being utilized corresponds to a selected treatment pathway and report the results of the determination. As such, the monitor 63 may be configured to monitor adherence within the organization to selected clinical treatment pathways.

The pathway analyzer 44 may therefore enable an organization, regardless of the size of the organization, to utilize local and/or remote resources to determine the most cost effective and clinically effective ways to treat certain illnesses such as cancer or other illnesses that typically have treatment pathways defined by drug prescription patterns. Organizations may use the information learned to provide information to payors to improve the quality of care that can be provided to patients, while reducing costs. Example embodiments may also provide transparency around the cost of delivering quality driven care to align the incentives between payors and provider. Some embodiments may help ensure that quality care is provided for patients while creating efficiency in practice workflow. Some embodiments may also improve contract positioning for organizations or practices with respect to payors by demonstrating aligned incentives and predictability of costs. Example embodiments may also provide preparation for the future of health care cost management including accountable care organizations, medical home models, episodic payments, and pay for performance. Some embodiments may also provide for a proactive and physician-led approach to bending the cost curve.

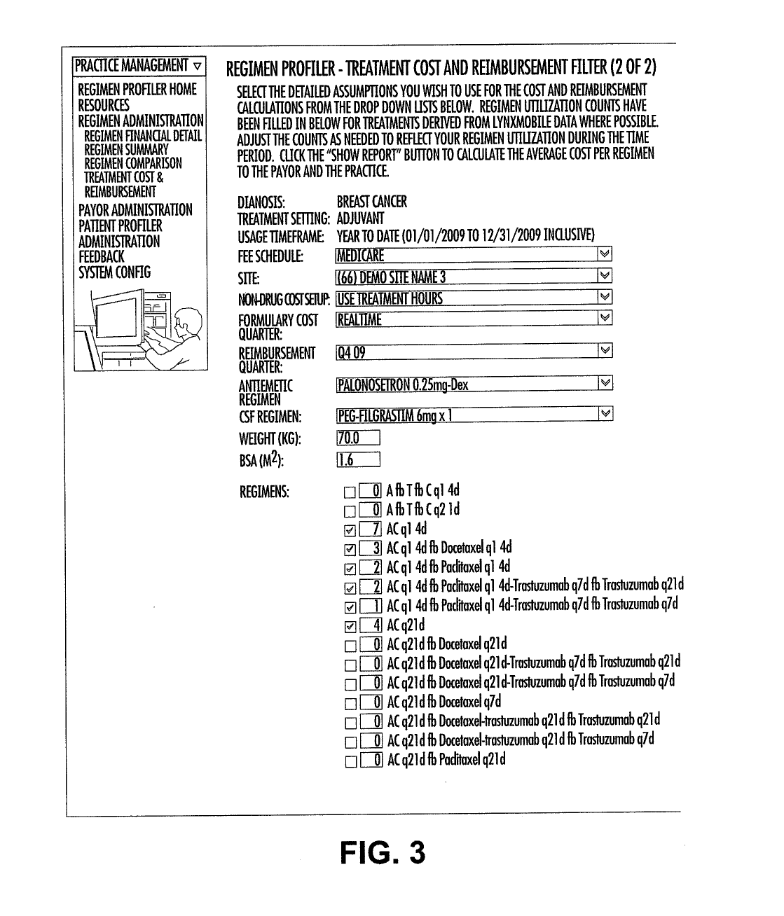

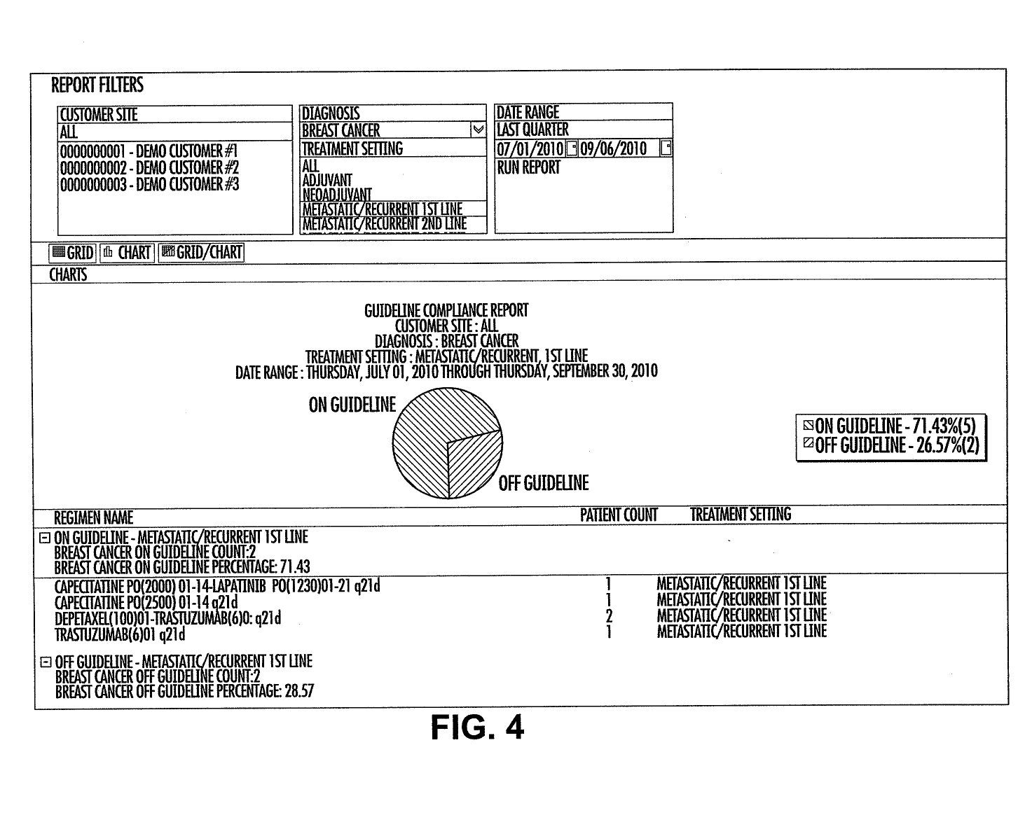

The pathway analyzer 44 may be configured to receive information and generate various reports via the report generator 70. The report generator 70 may be configured to provide a flexible user interface designed to enable users to navigate through various options and select the processing and/or report generation tools desired at any given time and for one or more organizations. In an example embodiment, the report generator 70 may be configured to provide a dashboard display providing a view of the reports generated. The reports may include reports regarding treatment and cost reimbursement (see FIG. 3), guideline compliance (see FIG. 4), cost versus efficacy and numerous other charts, graphs, and/or display formats. In some cases, recommendations may also be provided. In an example embodiment, the pathway analyzer 44 may generate a generic navigation structure including a main page from which various options such as cost savings information, clinical information, payor administration and other practice management tools may be accessed. Within each selectable area, control consoles may be provided to identify date ranges, treatment pathway identifiers, payors, patients and numerous other identifying pieces of data over which searches may be conducted or with respect to which information may be extracted.

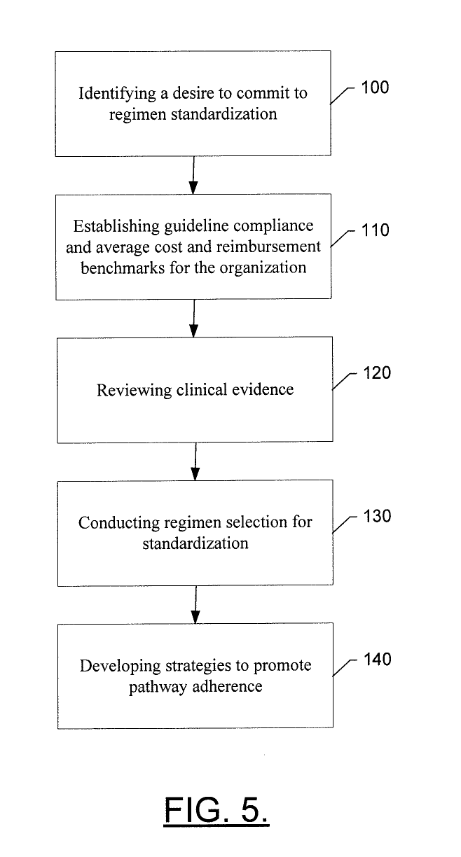

In some cases, use of the pathway analyzer 44 may be conducted via operational phases undertaken by an organization. FIG. 5 illustrates an example of the phases that may be associated with utilization of the pathway analyzer 44 to improve cost efficiency and efficacy of care provided using example embodiments. As shown in FIG. 5, the organization may identify a desire to commit to regimen standardization at operation 100. This phase may include internal communications and decision making within the organization to determine that regimen standardization should be pursued. Thereafter, a guideline compliance and average cost and reimbursement benchmark may be established for the organization at operation 110. The benchmark may be established using the pathway analyzer 44 to pull data over desirable date ranges and disease types. Reports may then be generated accordingly. Clinical evidence may then be reviewed at operation 120. Treatment pathways may be defined for various different disease types. The treatment pathways may have an identifier including any or all of a standardized name, descriptive name, serial number, or other identifying title. Treatment guidelines and other efficacy related information may be associated with corresponding treatment pathways to make the corresponding information available in association with the corresponding identifiers responsive to selection of a treatment pathway. When a treatment pathway identifier is selected, the corresponding information may be accessed to determine efficacy of different treatment pathways of interest within the clinical evidence review phase so that effective pathways may be selected for patient care.

In some cases, regimen selection for standardization may then be conducted at operation 130. Data pulled from previous phases may be used to select certain regimens as standardized regimens for the organization based on cost and efficacy. In some cases, the organization may implement internal discussion and review of suggested or selected regimens that are proposed for standardization until a final listing of regimens may be selected as standardized regimens. The standardized regimens may then be shared throughout the organization. Strategies may then be developed to promote pathway adherence at operation 140. In some cases, instructions, check-lists and/or other process streamlining techniques may be employed to facilitate organizational use of the standardized regimens. Monitoring activities may also be implemented using data accessible to the pathway analyzer 44 (e.g., via the monitor 63) to determine adherence to the standardized regimens on an organizational basis. In some cases, periodic reviews or compliance reports may be generated to enable adherence monitoring.

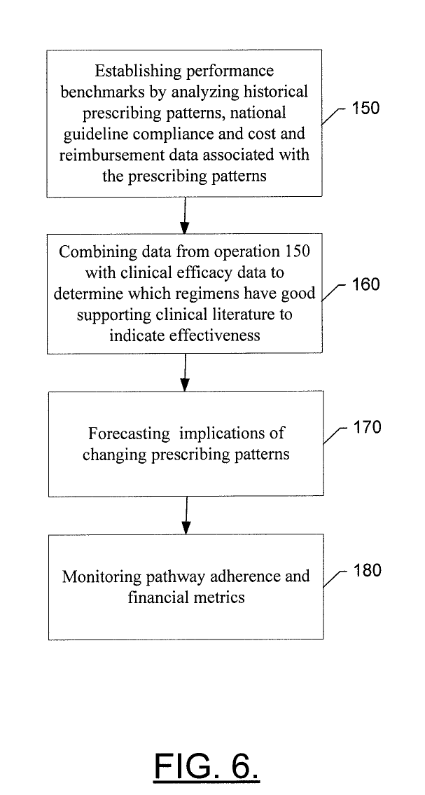

FIG. 6 illustrates a process flow for creating a pathway according to an example embodiment. As shown in FIG. 6, performance benchmarks may initially be established by analyzing historical prescribing patterns, national guideline compliance and cost and reimbursement data associated with the prescribing patterns at operation 150. At operation 160, data from operation 150 may be overlaid or otherwise combined with clinical efficacy data to determine which regimens have good supporting clinical literature to indicate effectiveness. Forecasting may then be performed to indicate the implications of changing prescribing patterns at operation 170. At operation 180, ongoing monitoring of pathway adherence and financial metrics may be performed.

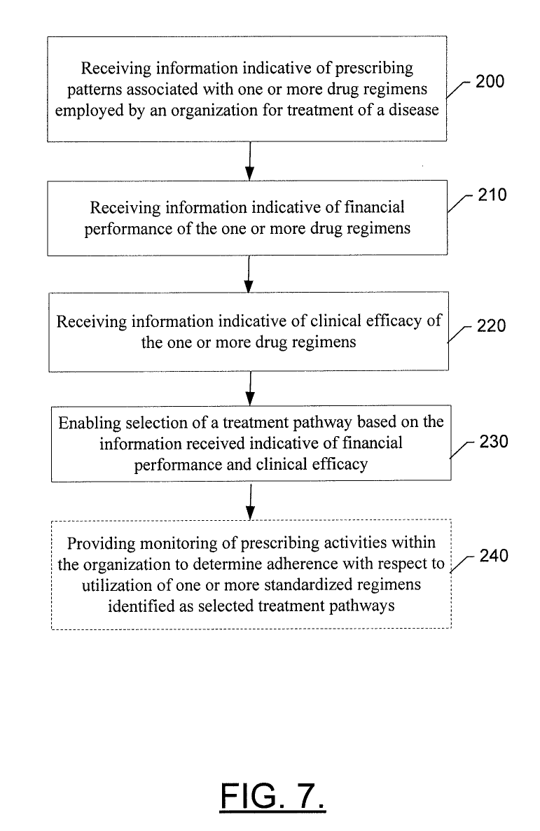

Embodiments of the present invention may therefore be practiced using an apparatus such as the one depicted in FIG. 2. However, other embodiments may be practiced in connection with a computer program product for performing embodiments of the present invention. FIG. 7 is a flowchart of a method and program product according to example embodiments of the invention. Each block or step of the flowchart of FIG. 7, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 54) and executed by processing circuitry (e.g., processor 52).

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s). These computer program instructions may also be stored in a non-transitory computer-readable storage medium comprising memory that may direct a computer or other programmable apparatus to function in a particular manner, such that the instructions stored in the computer-readable memory produce an article of manufacture including instructions to implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

In this regard, a method according to one embodiment of the invention, as shown in FIG. 7, may include receiving information indicative of prescribing patterns associated with one or more drug regimens employed by an organization for treatment of a disease at operation 200, receiving information indicative of financial performance of the one or more drug regimens at operation 210, receiving information indicative of clinical efficacy of the one or more drug regimens at operation 220, and enabling development of a treatment pathway based on the information received indicative of financial performance and clinical efficacy at operation 230.

In some cases, the method may include additional optional operations, an example of which is shown in dashed lines in FIG. 7. Any additional operations, and/or modifications to the operations above or the additional operations, may be performed in addition to the operations described above in any order and in any combination. Thus, in some embodiments, all of the additional operations or modifications may be practiced, while in others none of the additional operations or modifications may be practiced. In still other embodiments, any combination of less than all of the additional operations or modifications may be practiced. In an example embodiment, the method may further include providing monitoring of prescribing activities within the organization to determine adherence with respect to utilization of one or more standardized regimens identified as selected treatment pathways at operation 240. The method may alternatively or additionally include enabling generation of a report indicative of analysis of financial performance or clinical efficacy of one or more drug regimens via a dashboard. In some embodiments, receiving information indicative of prescribing patterns associated with one or more drug regimens further may include receiving information regarding external treatment pathways employed outside the organization and financial performance and clinical efficacy data corresponding to the external treatment pathways. In an example embodiment, enabling development of the treatment pathway may include enabling designation of one or more selected regimens for inclusion in a standardized treatment pathway to be employed by the organization. In some embodiments, receiving information indicative of one or more drug regimens employed by the organization may include receiving data indicative of national guidelines associated with treatment of the disease. Enabling development of the treatment pathway may include enabling generation of a report benchmarking the treatment pathway relative to the national guidelines. In an example embodiment, enabling development of the treatment pathway may include enabling generation of a report indicating a forecast of treatment cost or reimbursement amounts associated with the treatment pathway. Other modifications are also possible. The modifications and optional operations may be included in any combination and in any order with respect to the operations 200-240 described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving information indicative of prescribing patterns associated with one or more drug regimens employed by an organization for treatment of a disease;
receiving information indicative of financial performance of the one or more drug regimens;
receiving information indicative of clinical efficacy of the one or more drug regimens; and
enabling, via processing circuitry, development of a treatment pathway based on the information received indicative of financial performance and clinical efficacy.

2. The method of claim 1, wherein enabling development of the treatment pathway comprises enabling designation of one or more selected regimens for inclusion in a standardized treatment pathway to be employed by the organization.

3. The method of claim 1, further comprising enabling generation of a report indicative of analysis of financial performance or clinical efficacy of one or more drug regimens via a dashboard.

4. The method of claim 1, further comprising providing monitoring of prescribing activities within the organization to determine adherence with respect to utilization of one or more standardized regimens identified as selected treatment pathways.

5. The method of claim 1, wherein receiving information indicative of prescribing patterns associated with one or more drug regimens employed by the organization comprises receiving data indicative of national guidelines associated with treatment of the disease.

6. The method of claim 5, wherein enabling development of the treatment pathway comprises enabling generation of a report benchmarking the treatment pathway relative to the national guidelines.

7. The method of claim 1, wherein enabling development of the treatment pathway comprises enabling generation of a report indicating a forecast of treatment cost or reimbursement amounts associated with the treatment pathway.

8. An apparatus comprising processing circuitry configured to:
receive information indicative of prescribing patterns associated with one or more drug regimens employed by an organization for treatment of a disease;
receive information indicative of financial performance of the one or more drug regimens;
receive information indicative of clinical efficacy of the one or more drug regimens; and
enable development of a treatment pathway based on the information received indicative of financial performance and clinical efficacy.

9. The apparatus of claim 8, wherein the processing circuitry being configured to enable development of the treatment pathway comprises the processing circuitry being configured to enable designation of one or more selected regimens for inclusion in a standardized treatment pathway to be employed by the organization.

10. The apparatus of claim 8, wherein the processing circuitry is further configured to enable generation of a report indicative of analysis of financial performance or clinical efficacy of one or more drug regimens via a dashboard.

11. The apparatus of claim 8, wherein the processing circuitry is further configured to provide monitoring of prescribing activities within the organization to determine adherence with respect to utilization of one or more standardized regimens identified as selected treatment pathways.

12. The apparatus of claim 8, wherein the processing circuitry being configured to receive information indicative of prescribing patterns associated with one or more drug regimens employed by the organization comprises the processing circuitry being configured to receive data indicative of national guidelines associated with treatment of the disease.

13. The apparatus of claim 12, wherein the processing circuitry being configured to enable development of the treatment pathway comprises the processing circuitry being configured to enable generation of a report benchmarking the treatment pathway relative to the national guidelines.

14. The apparatus of claim 9, wherein the processing circuitry being configured to enable development of the treatment pathway comprises the processing circuitry being configured to enable generation of a report indicating a forecast of treatment cost or reimbursement amounts associated with the treatment pathway.

15. A computer program product comprising at least one computer-readable storage medium having computer-executable program code instructions stored therein, the computer-executable program code instructions comprising program code instructions for:
receiving information indicative of prescribing patterns associated with one or more drug regimens employed by an organization for treatment of a disease;
receiving information indicative of financial performance of the one or more drug regimens;
receiving information indicative of clinical efficacy of the one or more drug regimens; and
enabling development of a treatment pathway based on the information received indicative of financial performance and clinical efficacy.

16. The computer program product of claim 15, wherein program code instructions for enabling development of the treatment pathway include instructions for enabling designation of one or more selected regimens for inclusion in a standardized treatment pathway to be employed by the organization.

17. The computer program product of claim 15, wherein program code instructions for enabling development of the treatment pathway include instructions for enabling generation of a report indicative of analysis of financial performance or clinical efficacy of one or more drug regimens via a dashboard.

18. The computer program product of claim 15, further comprising program code instructions for providing monitoring of prescribing activities within the organization to determine adherence with respect to utilization of one or more standardized regimens identified as selected treatment pathways.

19. The computer program product of claim 15, wherein program code instructions for receiving information indicative of prescribing patterns associated with one or more drug regimens employed by the organization include instructions for receiving data indicative of national guidelines associated with treatment of the disease.

20. The computer program product of claim 19, wherein program code instructions for enabling development of the treatment pathway include instructions for enabling generation of a report benchmarking the treatment pathway relative to the national guidelines.

21. The computer program product of claim 15, wherein program code instructions for enabling development of the treatment pathway include instructions for enabling generation of a report indicating a forecast of treatment cost or reimbursement amounts associated with the treatment pathway.
